(19) United States
(12) Patent Application Publication
(10) Pub. No.: US 2014/0052497 A1
(43) Pub. Date: Feb. 20, 2014

(54) CORRELATING LOCATION DATA

(71) Applicants: Thomas Varghese, Los Altos, CA (US); Konstantin Othmer, Los Altos Hills, CA (US)

(72) Inventors: Thomas Varghese, Los Altos, CA (US); Konstantin Othmer, Los Altos Hills, CA (US)

(21) Appl. No.: 13/762,246

(22) Filed: Feb. 7, 2013

Related U.S. Application Data
(60) Provisional application No. 61/596,110, filed on Feb. 7, 2012.

(51) Int. Cl. G06Q 30/02; G06Q 20/38; G06Q 20/32

(52) U.S. Cl. CPC G06Q 30/0205; G06Q 20/3224; G06Q 20/382
USPC 705/7.34; 705/44

(57) ABSTRACT

An example embodiment includes a method of associating mobile devices with transactional entities. The method includes identifying a first transaction performed by a first transactional entity and identifying a first set of mobile devices in a location of the first transaction at a time of the first transaction. The method further includes identifying a second transaction performed by the first transactional entity and identifying a second set of mobile devices in a location of the second transaction at a time of the second transaction. The first set of mobile devices is compared to the second set of mobile devices. When a single mobile device is common to the first set of mobile devices and the second set of mobile devices, the single mobile device is associated with the first transactional entity.

### CROSS-REFERENCE TO RELATED APPLICATION

This application claims the benefit of and priority to U.S. Provisional Application No. 61/596,110 filed on Feb. 7, 2012 which is incorporated herein by reference in its entirety.

### FIELD

The present invention relates to identification of mobile devices associated with transactional entities. More particularly, some examples embodiments relate to identifying a transactional entity by correlating transactional data collected by an identifying entity with anonymous time/location data of mobile devices mined by a mining entity.

### BACKGROUND

Data mining generally refers to an automatic or a semiautomatic analysis or processing of large quantities of data. The analysis or processing may include collection, extraction, and/or storage of the large quantity of data. Data mining may allow the mining entity or another entity which purchases the data from the mining entity to summarize or detect patterns in the data using statistical and artificial intelligence methods. The patterns and the summaries can then be used to make predictions, determine dependencies, detect abnormalities, or adapt a related system.

An example of data mining is the mining of mobile device time/location data. This time/location data may be generated through pinging mobile devices by a network of cellular towers. The term “pinging” refers to sending a signal to a mobile device and timing the response to generate a distance. Three or more cellular towers ping a mobile device to triangulate the location of the mobile device at a specific time. The result is a location (usually coordinates) and time. The mining entities interface with cellular companies to collect and analyze the time/location data tracking multiple mobile devices. The mining entities may sell the time/location data to create, for example, real time traffic conditions, to detect marketing effectiveness, and/or to measure general consumer behavior. However, the mined data is anonymous, making it problematic to identify the mobile device associated with a specific transactional entity from the time/location data.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

An example embodiment includes a method of associating mobile devices with transactional entities. The method includes identifying a first transaction performed by a first transactional entity and identifying a first set of mobile devices in a location of the first transaction at a time of the first transaction. The method further includes identifying a second transaction performed by the first transactional entity and identifying a second set of mobile devices in a location of the second transaction at a time of the second transaction. The first set of mobile devices is compared to the second set of mobile devices. When a single mobile device is common to the first set of mobile devices and the second set of mobile devices, the single mobile device is associated with the first transactional entity.

Another example embodiment includes a method of identifying a mobile device associated with a selected transactional entity. The method includes receiving time/location data indicating locations of multiple mobile devices at a set of times and receiving transactional data generated during the performance of transactions. The transactional data includes for each of the transactions a time, a location, and a transactional entity that performed the transaction. The method further includes organizing the transactional data to enable identification of a first time and a first location for a first transaction performed by the selected transactional entity. From the time/location data, a list of mobile devices in the first location at the first time of the performance of the first transaction is determined. When the list of mobile devices includes a single mobile device, the single mobile device is associated with the selected transactional entity.

Another example embodiment includes a method of conducting a secured transaction with a selected transactional entity operating a mobile device. The method includes receiving time/location data indicating locations of multiple mobile devices at a set of times and receiving transactional data generated during the performance of transactions. The transactional data includes for each of the plurality of transactions a time, a location, and a transactional entity that performed the transaction. One or more prior transactions from the transactions in which the selected transactional entity was involved are identified. From the time/location data, sets of mobile devices in the locations and at the times of the prior transactions are identified. The sets of mobile devices are compared to determine a single mobile device associated with the selected transactional entity. The method also includes soliciting the selected transactional entity to participate in a secured transaction.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are, therefore, not to be considered limiting of its scope. The invention will be described and explained with additional specificity and detail through the use of the accompanying drawings in which:

FIG. 1 illustrates a block diagram of an example identification system;

FIG. 2 illustrates an example data mining system which may be implemented in the identification system of FIG. 1;

FIG. 3 illustrates an example of transactional data that may be used in the identification system of FIG. 1;

FIGS. 4A-4C illustrate an example of time/location data that may be used in the identification system of FIG. 1;

FIG. 5 is a flow diagram of an example correlation process that may be used in the identification system of FIG. 1;

FIG. 6 is a flow diagram of another example correlation process that may be implemented in the identification system of FIG. 1;

FIG. 7 is a flow diagram of an example method of associating mobile devices with transactional entities that may be implemented by the identification system of FIG. 1;

FIG. 8 is a flow diagram of an example method of identifying a mobile device associated with a selected transactional entity that may be implemented by the identification system of FIG. 1; and

FIG. 9 is a flow diagram of an example method of conducting a secured transaction that may be implemented by the identification system of FIG. 1.

### DESCRIPTION OF SOME EXAMPLE EMBODIMENTS

Embodiments described herein relate to identification of mobile devices associated with transactional entities. More particularly, some example embodiments relate to identifying a mobile device associated with a transactional entity by correlating transactional data collected by an identifying entity with anonymous time/location data of mobile devices mined by a mining entity. Some additional embodiments will be described with reference to the appended drawings.

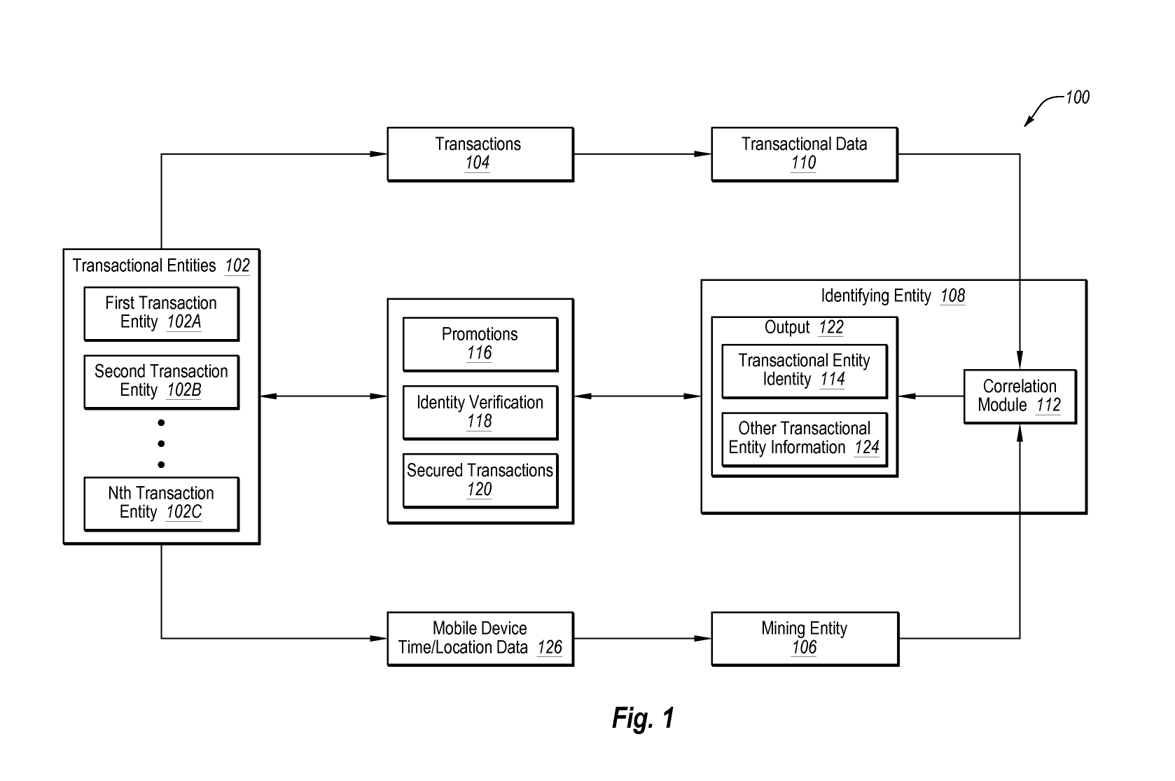

Referring to FIG. 1, an example identification system 100 is depicted. The identification system 100 may include transactional entities 102 that perform one or more transactions 104. The transactional entities 102 may include users, each associated with one or more mobile devices (not shown). The transactional entities 102 are shown grouped in some fashion in FIG. 1; however, the transactional entities 102 may or may not be related geographically, physically, etc.

The identification system 100 includes three transactional entities, a first transactional entity 102A, a second transactional entity 102B, and an nth transactional entity 102C. However, this depiction is not meant to be limiting. Inclusion of the nth transactional entity 102C and the ellipses is meant to represent that the identification system 100 may include more than three transactional entities 102. Additionally, the identification system 100 may include fewer than three transactional entities 102.

The transactional entities 102 perform the transactions 104. As used herein, the term “perform” may relate to any execution, doing, or carrying out of one or more transactions 104, whether intentionally caused by one of the transactional entities 102 or automatically instigated in a device associated with or controlled by the transactional entities 102. The transactional entities 102 may perform transactions 104 over a computer network (not shown) or in person. The computer network relates to a collection of devices interconnected by communication channels that allows sharing of information among the interconnected devices. In this and other embodiments, the computer network may be or include any wired or wireless network technology such as optical fiber, electrical cables, Ethernet, radio wave, microwaves, infrared transmission, wireless internet, communication satellites, cellular telephone signals, or an equivalent networking signal that interfaces with devices to create a network.

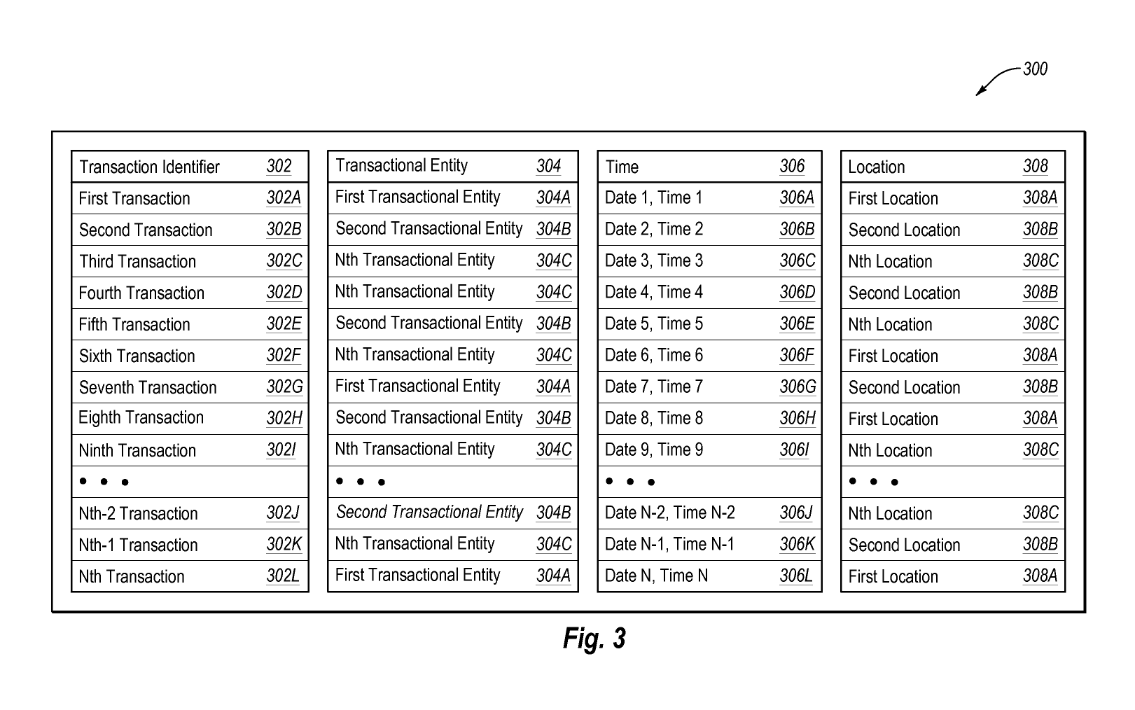

The transactions 104 may include, but are not limited to, any instance of commerce including, but not limited to, economic transactions, inquiries such as through a search engine, and/or correspondences between the transactional entities 102 or between one of the transactional entities 102 and an identifying entity 108. By performing transactions 104, transactional data 110 may be produced. The transactional data 110 may be fed into a correlation module 112, which may be located within or owned by the identifying entity 108. Some additional details of the transactional data 110 are discussed with reference to FIG. 3. The identifying entity 108 may store the transactional data 110 and/or perform some processing or analysis on the transactional data 110. For example, in some embodiments, the identifying entity 108 may simply collect transactional data 110 in a raw form. Additionally or alternatively, the identifying entity may process the transactional data 110 to refine, sort, filter, process, or clarify the transactional data 110. In circumstances in which the identifying entity 108 performs some processing, the transactional data 110 may include transactional data 110 that has been subject to some process.

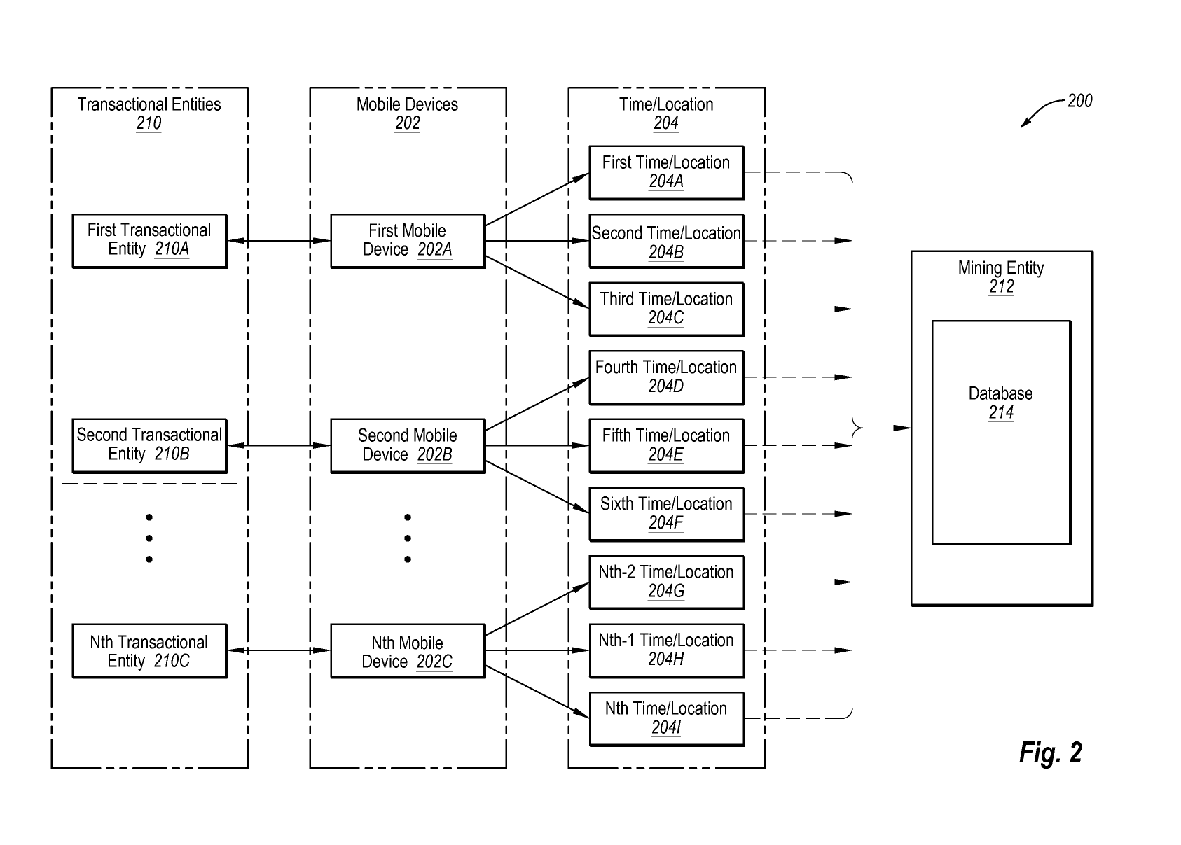

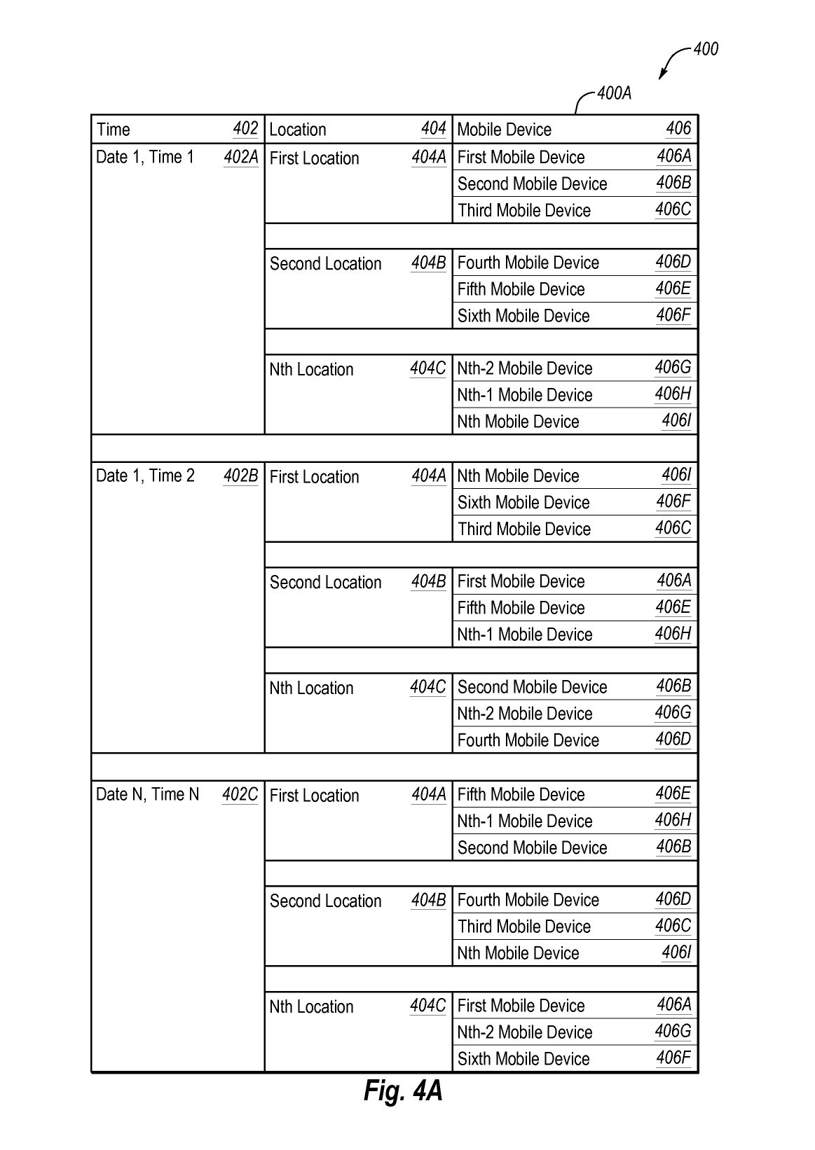

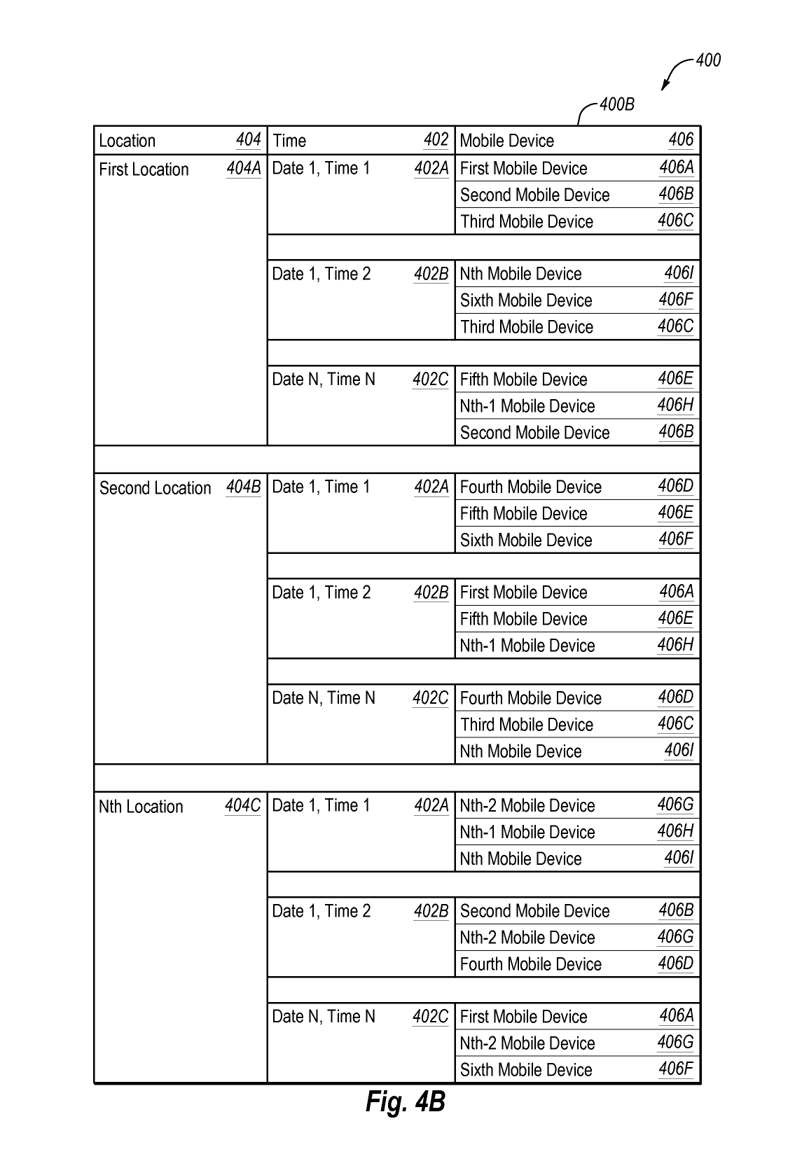

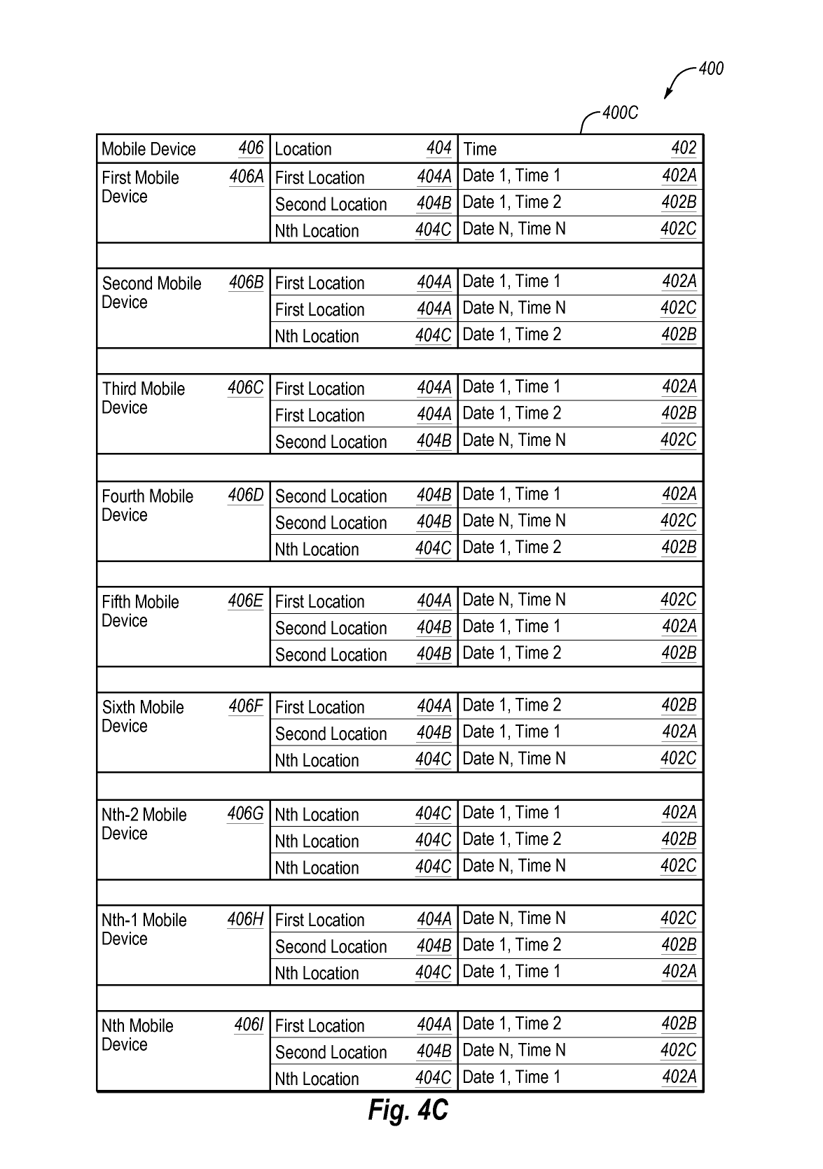

In addition to performing the transactions 104, the transactional entities 102 may generate mobile device time/location data (time/location data) 126. The time/location data 126 may include information pertaining to the location of one or more mobile devices owned, associated with, and/or under control of the transactional entities 102 at a series or set of times. An example of the time/location data 126 is discussed with reference to FIGS. 2 and 4. Briefly, the time/location data 126 can be used as a location of one of the transactional entities 102 at a time. More specifically, detecting the location of a mobile device can implicitly determine the location of a transactional entity 102 associated with the mobile device. The time/location data 126 in some embodiments includes an imprecise (network accurate) location of mobile devices that may be obtained through pinging the mobile devices by a network of cellular towers and/or by measuring an intensity of a wireless fidelity (Wi-Fi) or other wireless signal communicated between the mobile device and one or more Wi-Fi access points (Wi-Fi AP or Wi-Fi APs).

A mining entity 106 may mine the time/location data 126 generated by the transactional entities 102. The process of mining by the mining entity 106 may occur over the computer network. The mining entity 106 may store the time/location data 126 and/or perform some processing or analysis on the time/location data 126. For example, in some embodiments, the mining entity 106 may simply collect time/location data 126 in a raw form. Additionally or alternatively, the mining entity 106 may process the time/location data 126 to refine, sort, filter, process, or clarify the time/location data 126.

The mining entity 106 may then transfer the time/location data 126 to the identifying entity 108. The transfer of the time/location data 126 may be conducted through the computer network. Additionally, the transfer of the time/location data 126 may include an economic exchange of the time/location data 126 for some commercial gain. Additionally or alternatively, the transfer may be conducted through a transfer of information on a computer-readable medium such as a disk or drive.

In some embodiments, the transfer may be conducted in real time. In these and other embodiments, as the time/location data 126 is being generated, the mining entity 106 may mine the time/location data 126 and simultaneously (or with some small delay) transfer the time/location data 126 to the identifying entity 108. Alternatively or additionally, the mining entity 106 may batch transfer the time/location data 126 periodically at an existing or a set schedule.

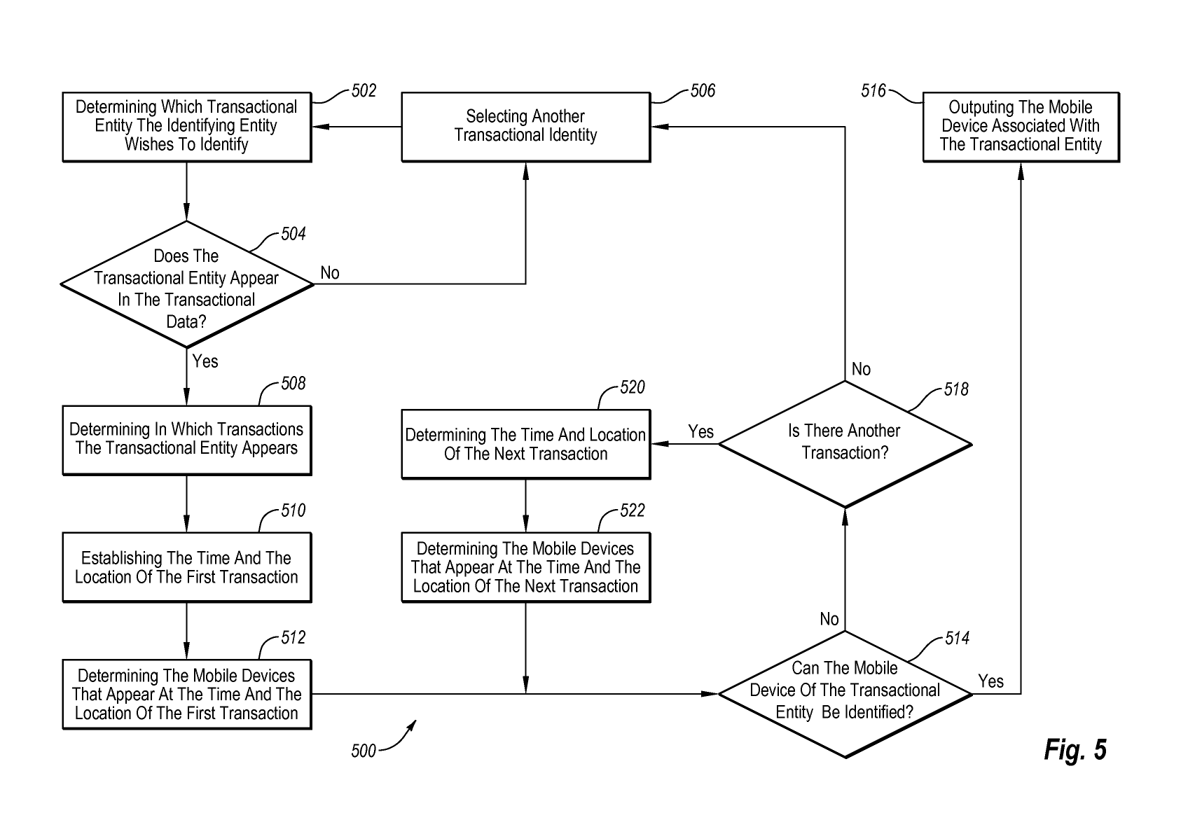

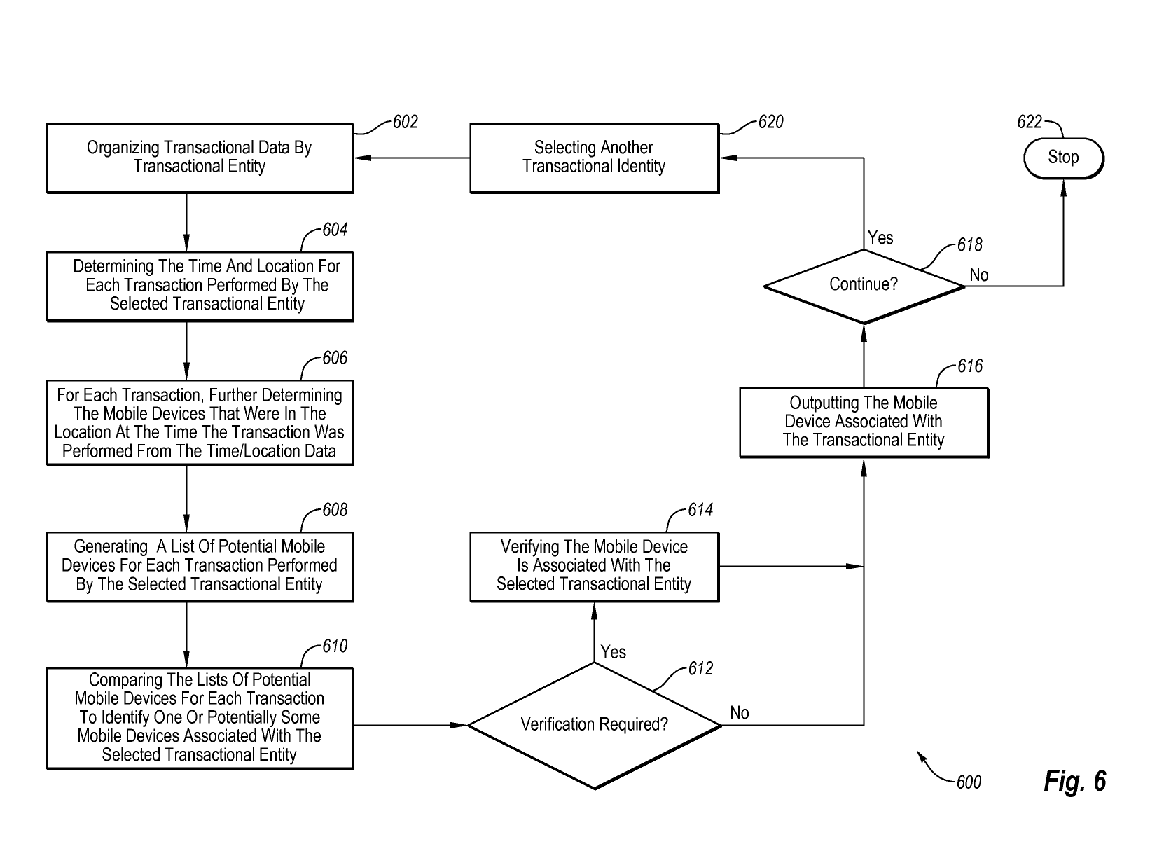

The identifying entity 108 receives the time/location data 126 from the mining entity 106. The identifying entity 108 may input the time/location data 126 into the correlation module 112. Some aspects of an example correlation module 112 are described below with respect to FIGS. 5 and 6. Additionally or alternatively, the identifying entity 108 may store some or all of the time/location data 126 for later or alternative uses.

The correlation module 112 may be purchased and operate at a place of business of the identifying entity 108 or be operated at a remote location generally accessible or operably commutating with the identifying entity 108. The correlation module 112 may be embodied as computer-executable instructions or program code that, when executed by a computing device, performs one or more of the operations described herein. Alternately or additionally, such computer-executable instructions or program code may be stored on a computer-readable storage medium.

The correlation module 112 receives as input the transactional data 110 and the time/location data 126 and generates some output 122. The output 122 may include a transactional entity identity 114 and other transactional entity information 124. The transactional entity identity 114 may include, for example, a specific association of a mobile device to a specific transactional entity. For example, the transactional entity identity 114 may include “mobile device A is associated with the first transactional entity 102A.”

The other transactional entity information 124 may include additional information related to one or more transactional entities 102 determined by the correlation module 112. Additionally or alternatively, the other transactional entity information 124 may include a relationship between the transactional entity identity 114 and the time/location data 126 transferred by the mining entity 106. The other transactional entity information 124 may include, but is not limited to, a set of possible transactional entities 102, a transactional history related to the transactional entity 102 identified by the correlation module 112, a present location, a pattern of typical transactions, etc.

As further illustrated in FIG. 1, the output 122 including the transactional entity identity 114 and the other transactional entity information 124 may remain with the identifying entity 108. The identifying entity 108 may use the output 122 in a variety of ways. For example, the identifying entity 108 may use the transactional entity identity 114 and perhaps the present location to prepare for a physical interaction. That is, if the transactional entity identity 114 identified is the first transactional entity 102A whose present location is near or at the place of business of the identifying entity 108, a proprietor of the identifying entity 108 may better prepare for an in-person encounter with the first transactional entity 102A.

Additionally or alternatively, the identifying entity 108 may use the transactional entity identity 114 for directed advertising. For example, if the first transactional entity 102A was identified by the correlation module 112, then the identifying entity 108 may send to the first transactional entity 102A one or more promotions 116. The promotions 116 may include, for example, an advertisement, a survey, a thank you, a greeting, or some other commercial or personal correspondence. The promotions 116 may be sent via the computer network and may be received by the first transactional entity 102A at a device such as a smartphone or equivalent mobile device, aspects of which are discussed with reference to FIG. 2.

Additionally or alternatively, the identifying entity 108 may use the transactional entity identity 114 to verify whether a mobile device is associated with a transactional entity 102. The verification may result in fraud detection/elimination. For example, the correlation module 112 may determine that first transactional entity 102A is associated with a first mobile device (not shown). The identifying entity 108 may then send to the first transactional entity 102A an identity verification 118 to verify that the first transactional entity 102A is indeed associated with the first mobile device. The first transactional entity 102A may respond or otherwise validate the reception of the identity verification 118.

Alternatively or additionally, following the identity verification 118, the identifying entity 108 may solicit the first transactional entity 102A to participate in secured transactions 120. The secured transactions 120 may include, but are not limited to, a search through private documents, access to protected information, a purchase of an expensive or exclusive product, a transfer of funds between accounts held by the first transactional entity 102A, etc. Because the first transactional entity 102A has been independently identified by the correlation module 112, the identifying entity 108 can have confidence in the association between the first transactional entity 102A and a specific mobile device inputting information into the secured transaction 120.

A potential benefit of the identification system 100 is demonstrated by the above example. The identifying entity 108 may validate the association between a specific mobile device and one of the transactional entities 102 through no affirmative representation (or alternatively, few representations) made by any of the transactional entities 102. Thus, use of the identification system 100 may be configured to not rely on or require input from the transactional entities 102. In an additional example, the identifying entity 108 may be a bank and the first transactional entity 102A may be a customer of the bank. Rather than the bank prompting the customer for a password and a username, the bank may allow the customer to perform a secured transaction securely from a specific mobile device because the bank has independently verified the customer's association with the specific mobile device.

FIG. 2 illustrates an example data mining system 200 that may be implemented in the identification system 100 of FIG. 1. The data mining system 200 may include one or more transactional entities 210, which operate one or more mobile devices 202. The transactional entities 210 may be substantially similar to and/or correspond to the transactional entities 102 of FIG. 1.

The transactional entities 210 include a first transactional entity 210A, a second transactional entity 210B, and an nth transactional entity 210C. Additionally, the mobile devices 202 may include a first mobile device 202A, a second mobile device 202B, and an nth mobile device 202C. The use of the nth transactional entity 210C and the nth mobile device 202C along with the ellipses are meant to indicate that the data mining system 200 illustrated in FIG. 2 may include more than three transactional entities 210 and more than three mobile devices 202. Also, the example data mining system 200 depicts each transactional entity 210 being associated with or operating a single mobile device 202. For example, as depicted in FIG. 2, first transactional entity 210A is associated with or operates the first mobile device 202A. However, in alternative embodiments, one or more of the transactional entities 210 may each operate or be associated with multiple mobile devices 202.

Each of the transactional entities 210 may include, but is not limited to, a person, a corporation, a government, or public organization. In alternative embodiments, the transactional entities 210 may include one transactional entity 210 within which other transactional entities 210 exist. For example, a first transactional entity 210A may include a second transactional entity 210B (illustrated in FIG. 2 as 210D), each of which may operate one or more mobile devices 202. The mobile devices 202 may include a laptop computer, a portable electronic device such as a cellular/mobile/smartphone, a tablet personal computer, a personal digital assistant, or any equivalent device.

In the data mining system 200, the mobile devices 202 operated by the transactional entities 210 may generate multiple time/locations 204. For example, a first mobile device 202A operated by the first transactional entity 210A may generate a first time/location 204A, a second time/location 204B, and a third time/location 204C. The example in FIG. 2 depicts three separate time/locations 204 (first time/location 204A thru third time/location 204C); however, FIG. 2 is illustrative only, and first mobile device 202A operated by first transactional entity 210A may generate multiple time/locations 204.

Each of the time/locations 204 is generated by the transactional entities 210 operating and transporting the mobile devices 202. More specifically, the time/locations 204 may be generated by a mobile device network (not shown) pinging the mobile devices 202 and/or measuring an intensity of a Wi-Fi signal communicated between the mobile devices 202 and one or more Wi-Fi APs (not shown). For example, the mobile devices 202 may be transmitting a signal to and/or receiving a signal from one or more cellular towers in the network at a particular time. The signal(s) may be analyzed to determine the time/location 204 of the mobile device 202. The time/locations 204 may be generated while the mobile devices 202 are actively operated by the transactional entities 210 such as during a telephone call. Alternately or additionally, the time/locations 204 may be generated while the mobile devices 202 are inactive such as between telephone calls. The mobile device network may be operated by a mobile service provider such as AT&T, Verizon, etc.

The time/locations 204 mined by a mining entity 212 are anonymous. Specifically, the transactional entity 210 controlling the mobile device 202 may not be ascertained from the mined time/location 208 itself, although the time/location may uniquely identify the mobile device 202 from which it was mined. Generally, the time/locations may include a unique identifier associated with the corresponding mobile device 202, locations specified in coordinates such as longitude and latitude, and a time at which the location was determined. The time/locations may be arranged according to time, according to location, or according to mobile device 202 as discussed with reference to FIG. 4. The time/location may be stored in a database 214, or may be sold to other entities by the mining entity 212.

The mining entity 212 may collect, extract, and/or analyze mined time/locations 208. The mining entity 212 may include a corporation, a software program, a government organization, or the like utilizing mining techniques. The data mining system 200 illustrated in FIG. 2 includes one mining entity 212; however, in alternative embodiments multiple mining entities may simultaneously or cooperatively mine the time/locations 204.

FIG. 3 illustrates an example of transactional data 300 that may be used in the identification system of FIG. 1. The transactional data 300 may correspond to the transactional data 110 of FIG. 1 in some embodiments. The transactional data 300 depicted in FIG. 3 is illustrative of one potential set of information included in transactional data 300 and one potential method for organizing the information in the transactional data 300. In alternative embodiments, the transactional data 300 may include any document, digital or print, or data structure that evidences a transaction. The transactional data 300 may be organized in various ways such as by transactional entity 304, time 306, location 308, etc. The transactional data 300 includes information from transactions performed between transactional entities, such as the transactional entities 102 of FIG. 1, and another entity, such as the identifying entity 108 of FIG. 1. For example, if an identifying entity is a bank, then the transactional data 300 may be the bank's records of each customer's transactions including when and where the transaction occurred.

The transactional data 300 may include one or more categories of information displayed in FIG. 3 vertically. For instance, the transactional data 300 includes the categories of: a transaction identifier 302, a transactional entity 304, the time 306, and the location 308. Vertically, each category (302, 304, 306, 308) includes a type of information related to a transaction. For example, the time 306 includes a set of times 306A-306L at which the transactions occurred Likewise, the location 308 includes a set of locations 308A-308C where the transactions occurred. The transaction identifier 302 similarly represents the transactional identifiers 302A-302L assigned to the transactions. In addition, the transactional entity 304 includes a set of transactional entities 304A-304C that perform the transactions.

Horizontally, the transactional data 300 is organized such that across a given row each piece of data in that row relates to a single transaction. For instance, a first transaction 302A was performed by a first transactional entity 304A, on date 1, time 1 306A at a first location 308A.

In the transactional data 300 three transactional entities, including the first transactional entity 304A, a second transactional entity 304B, and an nth transactional entity 304C, repeat in the transactional data 300. The repetition indicates that a transactional entity 304 performed multiple transactions. For example, the first transactional entity 304A performed the first transaction 302A, a seventh transaction 302G, and an nth transaction 302L. Likewise, three locations, including the first location 308A, a second location 308B, and an nth location 308C, repeat in the transactional data 300. The repetition indicates that multiple transactions occurred at one location 308. For example, the first transaction 302A, a sixth transaction 302F, an eighth transaction 302H, and an nth transaction 302L occurred at the first location 308A.

Additionally in the transactional data 300, the categories include “nth” values, specifically, nth-2 transaction 302J; nth-1 transaction 302K; nth transaction 302L; nth transactional entity 304C; nth location 308C; date n-2, time n-2 306J; etc. This notation indicates that the transactional data 300 may include any number of individual values in any of the categories (e.g., 302, 304, 306, 308).

FIGS. 4A-4C illustrate an example of time/location data 400 that may be used in the identification system of FIG. 1. The time/location data 400 may correspond to the time/location data 126 of FIG. 1, for instance. In the illustrated embodiment, the time/location data 400 includes three organizational tables: a time-based table 400A illustrated in FIG. 4A, a location-based table 400B illustrated in FIG. 4B, and a mobile device-based table 400C illustrated in FIG. 4C. Each of the organizational tables 400A-400C includes the same information organized in different ways. The time/location data 400 depicted in FIGS. 4A-4C is illustrative of a potential set of information included in time/location data and three potential configurations for organizing the information. In alternative embodiments, the time/location data 400 may include any document, digital or print, or data structure that evidences a time/location of a device and may be organized in various ways. Generally, the time/location data 400 includes locations of mobile devices at a set or series of times determined by pinging the mobile devices and/or by measuring an intensity of a Wi-Fi signal communicated between the mobile devices and one or more Wi-Fi APs.

Each of the tables 400A, 400B, and 400C of the time/location data 400 illustrated in FIGS. 4A-4C may include one or more categories (e.g., 402, 404, and 406) of information displayed vertically. The categories 402, 404, and 406 of time/location data 400 each includes a type of information related to a time/location of one or more mobile devices. Specifically, each of the tables illustrated in FIGS. 4A-4C the categories include time 402, location 404, and mobile device 406.

The time category 402 includes three times: a date 1, time 1 402A; a date 1, time 2 402A; a date n, time n 402C which indicate when the locations of the one or more mobile devices were determined. The location category 404 includes three locations: a first location 404A, a second location 404B, and an nth location 404C which indicate the location of one or more mobile devices at the corresponding time 402. The mobile device category 406 includes multiple mobile devices 406A-406L. The mobile device 406 of the time/location information 400 is anonymous with respect to the associated transactional entity. Thus, the identification of the first mobile device 406A does not indicate which transactional entity (102, FIG. 1) is associated with the mobile device 406.

Horizontally, the transactional data 300 is organized such that across a given row each piece of data relates to a single time/location. Referring to the time-based table 400A: on date 1, time 1 402A, a first mobile device 406A, a second mobile device 406B, and a third mobile device 406C were at first location 404A; fourth mobile device 406D, fifth mobile device 406E, and sixth mobile device 406F were at second location 404 B; and nth-2 mobile device 406G, nth-1 mobile device 406H, and nth mobile device 4061 were at nth location 404C.

In the time-based table 400A, the time/location data 400 is organized by time 402. Thus, a correlation module (e.g., correlation module 112, FIG. 1) of an identifying entity (e.g., identifying entity 108, FIG. 1) may search the time/location data 400 based on the time 402 Likewise, the location-based table 400B is organized by location 404 and the mobile device-based table 400C is organized by mobile device 406.

With combined reference to FIGS. 1 and 4A-4C, the time/location data 400 may be transferred to the identifying entity 108 by the mining entity 106 in a data structure formatted such as those shown in any one of the tables 400A-400C. Additionally or alternatively, the correlation module 112 may include the capacity to organize raw or unorganized time/location data 400 into any one of the tables 400A-400C or in alternative formats.

FIG. 5 is a flow diagram of an example correlation process 500 that may be used in the identification system of FIG. 1. The correlation process 500 may include one or more acts or operations as illustrated by one or more of blocks 502, 504, 506, 508, 510, 512, 514, 516, 518, 520, and/or 522. The correlation process 500 is described below with combined reference to FIG. 3.

In block 502, it is determined which transactional entity the identifying entity wishes to identify. In some embodiments, block 502 is performed manually. For example, an identifying entity may know or be aware of a specific transactional entity and want to determine which mobile device is associated with the specific transactional entity. In alternative embodiments, the correlation process 500 may be automatically carried out. In these and other embodiments, instead of step 502 being requested, transactional data and time/location data are automatically analyzed to determine which, if any, transactional entities may be identified. In correlation processes with automatic processes, one or more of the following operations may be included, any of which may be automatically initiated and/or completed.

In block 504, it is determined whether the transactional entity appears in the transactional data. The operation in block 504 may be accomplished by a search of the transactional entity 304 category of the transactional data 300. If the transactional entity does not appear in the transactional data, the correlation process 500 may select another transactional entity in block 506.

If the transactional entity appears in the transactional data, then the correlation process 500 may proceed to block 508. In block 508, the transactions in which the transactional entity appears may be determined. When the transactional entity 304 is found in the transactional data 300, each of the transactions corresponding to the transactional entity 304 may be flagged or marked. Alternately or additionally, a list of transactions performed by the transactional entity may be generated and used in block 518 discussed below. The transactions may be arbitrarily assigned an order: first, second, etc.

With respect to the first of the transactions performed by the transactional entity, in block 510 the time and the locations of the first transaction may be established. For example, if the transactional entity 304 identified in step 502 was first transactional entity 304A, the transactions 302 would be: first transaction 302A which occurred on date 1, time 1 306A at first location 308A; seventh transaction 302G which occurred on date 7, time 7 306G at second location 308G; and nth transaction 302L which occurred on date n, time n 306L at first location 308L.

In block 512, the mobile devices that appear at the time and the location of the first transaction are determined. Block 512 may relate to the time/location data such as the time/location data 400 of FIG. 4. The operation of block 512 may be carried out by taking the time and/or the location related to the transaction performed by the transactional entity and searching the time/location data by that time and/or location. Searching the time/location data by the time or the location may allow a determination of which mobile devices were present at the time and/or location when the transaction was performed. This determination may be designated as a first list.

In block 514, it is determined whether the mobile device of the transactional entity can be identified. This step may be accomplished by evaluating the first list. For example, if the first list indicates that only one mobile device was present at the time and/or location when the transactional entity performed the transaction, then the one mobile device may be associated with the transactional entity 516.

However, if the first list includes multiple mobile devices that are possibly associated with the transactional entity, then the correlation process 500 may continue to block 518. In block 518, it is determined whether there is another transaction performed by the transactional entity in the transactional data. If not, the correlation process 500 may return to block 506.

If it is determined at block 518 that there is another transaction in the transactional data that was performed by the transactional entity, the correlation process 500 may continue to block 520 where the time and location of the other transaction performed by the transactional entity are determined. Block 520 may be the same as block 510 discussed above except that another transaction from the transactional data is used.

In block 522, the mobile devices that appear at the times and the locations of the other transactions are determined. Like block 512, block 522 relates to the time/location data such as the time/location data 400 of FIG. 4. The operation of block 522 may carried out by taking the time and/or the location related to the transaction performed by the transactional entity and searching the time/location data by that time and/or location. Searching the time/location data by the time or the location allows a determination of which mobile devices were present at the time and/or location when the transaction was performed. This determination may be designated as a second list.

The next block 514 in the correlation process 500 determines whether the mobile device of the transactional entity can be identified. The operation of block 514 may now be accomplished by evaluating both the first list and the second list. For example, if the first list indicates that a first set of mobile devices were present at the time and/or location when the transactional entity performed the first transaction, this first set of mobile devices may be compared to a second set of mobile devices included in the second list. If only one mobile device is on both lists, then the one mobile device may be associated with the transactional entity at block 516. If not, the correlation process 500 may continue to block 518 and repeat until either there are no more transactions or the correlation process 500 determines the mobile device associated with the transactional entity.

Alternatively, instead of outputting the particular mobile device associated with the transactional entity, the correlation process 500 may output a set of possible mobile devices that can be further correlated at a later time (not shown) using additional transactional data according to the correlation process 500 of FIG. 5, for instance.

Accordingly, some embodiments described herein can correlate location data with mobile devices to associate identified mobile devices with transactional entities. In some cases, it may be difficult to pinpoint the transactional entity from a single data set when multiple devices are at the same location. However, by analyzing multiple data sets over time, it may be possible to pinpoint the transactional entity in a few iterations, as the probability of the same set of mobile devices showing up at each visit may be relatively low.

FIG. 6 is a flow diagram of another example correlation process 600 that may be implemented in the identification system of FIG. 1. The correlation process 600 includes one or more acts or operations as illustrated by one or more of blocks 602, 604, 606, 608, 610, 612, 614, 616, 618, 620, and/or 622. The correlation process 600 is described below with combined reference to FIGS. 3 and 4A-4C.

In block 602, transactional data may be organized by transactional entity. The operation of block 602 may be accomplished by sorting or searching the transactional data 300 to determine which transactions 302 were performed by each transactional entity 304. For example, if the transactional data 300 was organized in the depicted manner, the result may be the first transactional entity 304A organized with the first transaction 302A, the seventh transaction 302G, and the nth transaction 302L; the second transactional entity 304B organized with the second transaction 302B, the fifth transaction 302E, the eighth transaction 302H, and the nth-2 transaction 302J; and the nth transactional entity 304C organized with the third transaction 302C, the fourth transaction 302D, the sixth transaction 302F, the ninth transaction 3021, and the nth-1 transaction 302K. The transactional entities 304 may be organized in some order or otherwise selected to proceed to the block step 604.

In block 604, the time and location for each transaction performed by the selected transactional entity may be determined. The operation of block 604 may be accomplished by sorting or searching the transactional data 300. For example, if the first transactional entity 304A is selected, the times 306 and location 308 for each of the first transaction 302A, seventh transaction 302G, and nth transaction 302L may be determined (e.g., first transaction 302A occurred on date 1, time 1 306A at the first location 308A).

In block 606, for each transaction, the mobile devices that were in the location at the time the transaction was performed from the time/location data may be further determined. Similar to blocks 512 and 522 of FIG. 5, in the correlation process 600 the time and location of each transaction may then be used as search criteria in the time/location data. Continuing the example from above, if the first transactional entity was selected, then the time/location data 400 may be searched for date 1, time 1 402A (306A, FIG. 3) at first location 404A (308A, FIG. 3). The determination in this example may provide the first mobile device 406A, the second mobile device 406B, and the third mobile device 406C. Similarly, the times and locations may be used to determine the mobile devices that were in the location at the time of the other transactions.

In block 608, a list of potential mobile devices for each transaction performed by the selected transactional entity may be generated. For instance, a first list generated for the first transaction may include the first mobile device 406A, the second mobile device 406B, and third mobile device 406C. Similar lists of potential mobile devices would be generated for each transaction performed by the selected transactional entity.

In block 610, the lists of potential mobile devices for each transaction may be compared to identify one or potentially some mobile devices associated with the selected transactional entity. As discussed above, each list can include one or more potential mobile devices associated with the selected transactional entity. Comparing the lists to identify common mobile devices narrows the number of potential mobile devices that can be associated with the selected transactional entity.

For example, the first list may include the first mobile device 406A, the second mobile device 406B, and the third mobile device 406C. A second list could include the fourth mobile device 406D, the sixth mobile device 406F, the first mobile device 406A, and the second mobile device 406B. A third list may include the second mobile device 406B and a tenth mobile device (not shown). Comparing the lists may result in the second mobile device 406B being the common mobile device on all lists that is identified as being associated with the first transactional entity.

In some alternative embodiments, block 610 may generate multiple mobile devices that may be associated with the selected transactional entity. In either case, the one or the multiple potential mobile devices may be verified. The determination of whether or not to verify the mobile device associated with the selected transactional entity may be made in block 612. If verification is not required, the correlation process 600 may continue to block 616 where the mobile device associated with the selected transactional entity is output.

If verification is required, the correlation process 600 may continue to block 614 which may include verifying the mobile device is associated with the selected transactional entity. The operation of block 614 may be accomplished through the identifying entity communicating an identity verification, such as the identity verification 118 of FIG. 1, to the selected transactional entity.

Alternatively, the correlation process 600 may include the operation of block 614 through additional monitoring of the time/location data. For example, referring to FIG. 4C, the time/location data 400 may be organized into the mobile device-based table 400C. If the correlation process 600 determines that a mobile device 406 such as first mobile device 406A is associated with a first transactional entity, the correlation process 600 may use the location 404 and the time 402 related to the mobile device 406 and check this time/location data 400 against additional transactional data to ensure the mobile device is associated with the selected transactional entity.

Following block 614, the correlation process 600 may continue to block 616 where the mobile device associated with the transactional entity is output. In the correlation process 600, after outputting the mobile device, a determination of whether or not to continue may be made at block 618. If not, the correlation process 600 may be stopped at block 612. If so, the next transactional entity may be selected in block 620 and the correlation process 600 may be repeated.

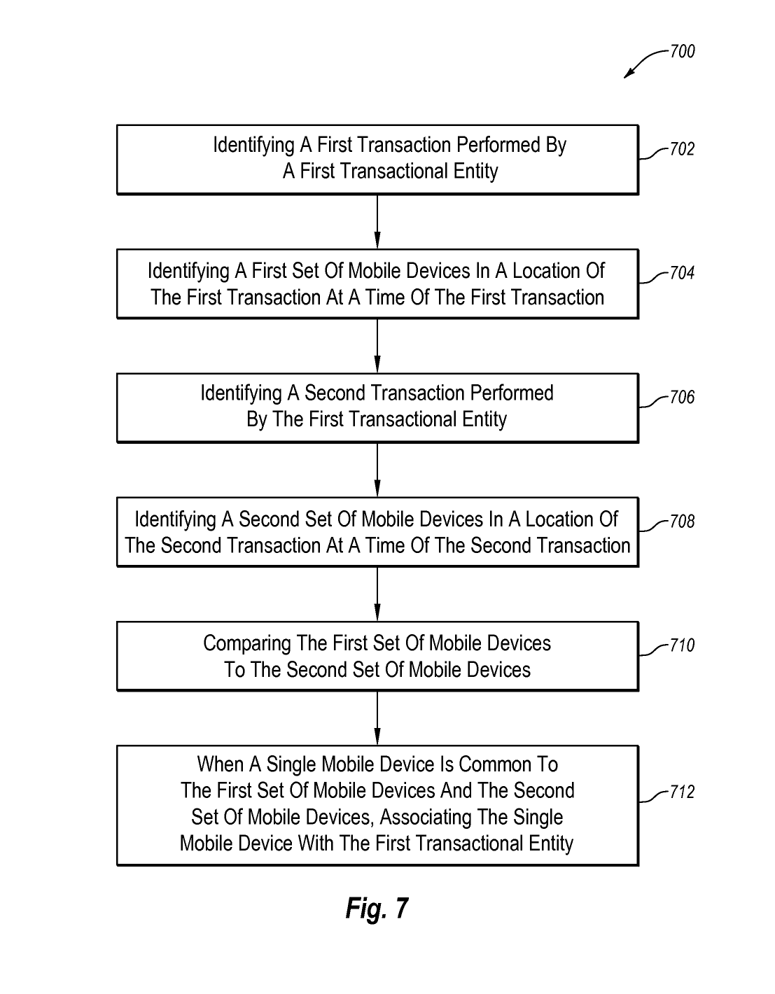

FIG. 7 is a flow diagram of an example method 700 of associating mobile devices with transactional entities. In some embodiments, the method 700 may be implemented by the identification system 100 of FIG. 1. Although illustrated as discrete blocks, various blocks may be divided into additional blocks, combined into fewer blocks, or eliminated, depending on the desired implementation.

The method 700 may begin at 702 by identifying a first transaction performed by a first transactional entity. The first transaction may be identified from transactional data generated by transactional entities performing transactions on mobile devices.

At 704, the method 700 may include at a time of the first transaction, identifying a first set of mobile devices in a location of the first transaction. The first set of mobile devices may be identified from time/location data generated by pinging mobile devices by a network of cellular towers or by measuring an intensity of a wireless fidelity (Wi-Fi) signal between the mobile devices and one or more Wi-Fi access points.

At 706, the method 700 may include identifying a second transaction performed by the first transactional entity. At 708, a second set of mobile devices in a location of the second transaction and at the time of the second transaction is identified. As above, the second transaction may be identified from transactional data and the second set of mobile devices may be identified from time/location data by pinging mobile devices.

At 710, the first set of mobile devices is compared to the second set of mobile devices. At 712, when a single mobile device is common to the first set of mobile devices and the second set of mobile devices, the single mobile device is associated with the first transactional entity.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, when multiple mobile devices are common to the first set of mobile devices and the second set of mobile devices, the method 700 may further include identifying a third transaction performed by the first transactional entity. A third set of mobile devices in a location of the third transaction at a time of the third transaction is identified. The first set of mobile devices, the second set of mobile devices, and the third set of mobile devices are compared. When a single mobile device is common to the first set of mobile devices, the second set of mobile devices, and the third set of mobile devices, the single mobile device is associated with the first transactional entity.

Additionally or alternatively, in some embodiments, the method 700 may include analyzing the transactional data and the time/location data to determine other transactional information related to the first transaction entity. Analyzing the transactional data may include correlating the location and the time of the first transaction with the time and the location of the second transaction to determine a transactional history of the first transactional entity, a pattern of typical transactions of the first transactional entity, or a present location of the first transactional entity.

Additionally or alternatively, in some embodiments, the method 700 may include verifying that the first transactional entity is associated with the single mobile device. Verifying that the first transactional entity is associated with the single mobile device may include communicating an identity verification to the single mobile device, receiving a response from the first transactional entity validating that the first transactional entity is associated with the single mobile device, and soliciting the first transactional entity to participate in a secured transaction. The secured transaction may include, for example, searching a private document, accessing protected information, purchasing a product, or transferring funds between accounts held by the first transactional entity.

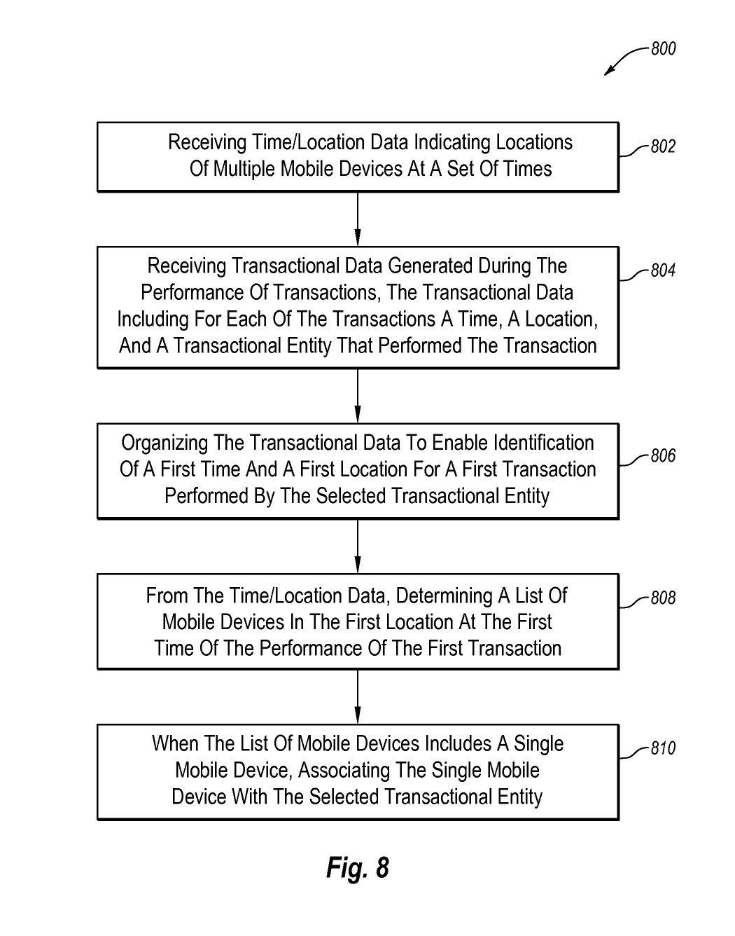

FIG. 8 is a flow diagram of an example method 800 of identifying a mobile device associated with a selected transactional entity. In some embodiments, the method 800 may be implemented by the identification system 100 of FIG. 1. Although illustrated as discrete blocks, various blocks may be divided into additional blocks, combined into fewer blocks, or eliminated, depending on the desired implementation.

The method 800 may begin at 802 by receiving time/location data indicating locations of multiple mobile devices at a set of times and at 804 by receiving transactional data generated during the performance of multiple transactions. The transactional data may include for each of the plurality of transactions a time, a location, and a transactional entity that performed the transaction.

At 804, the method 800 may include organizing the transactional data to enable identification of a first time and a first location for a first transaction performed by the selected transactional entity. At 806, from the time/location data, a list of mobile devices in the first location at the first time of the performance of the first transaction is determined. At 808, when the list of mobile devices includes a single mobile device, the single mobile device is associated with the selected transactional entity.

In some embodiments, when the list of mobile devices includes multiple mobile devices, the method 800 may include organizing the transactional data to enable identification of times and locations for each of the transactions performed by the selected transactional entity. From the time/location data, a set of mobile devices in each of the locations and at each of the times of the performance of each of the transactions performed by the selected transactional entity is determined. The sets of mobile devices are compared to generate a list of possible mobile devices associated with the selected transactional entity.

Additionally, in some embodiments, the method 800 may include communicating an identity verification to each of the mobile devices included in the list of possible mobile devices and validating that one of the mobile devices included in the list of possible mobile devices is associated with the selected transactional entity through reception of a response to the identity verification.

Additionally, in some embodiments, the method 800 may include correlating the locations and the times of one or more subsets of the plurality of transactions performed by the selected transactional entity to determine a transactional history of the selected transactional entity, a pattern of typical transactions of the selected transactional entity, or a present location of the selected transactional entity.

Additionally, in some embodiments, the method 800 may include outputting the list of possible mobile devices to an identifying entity. The identifying entity may be a bank.

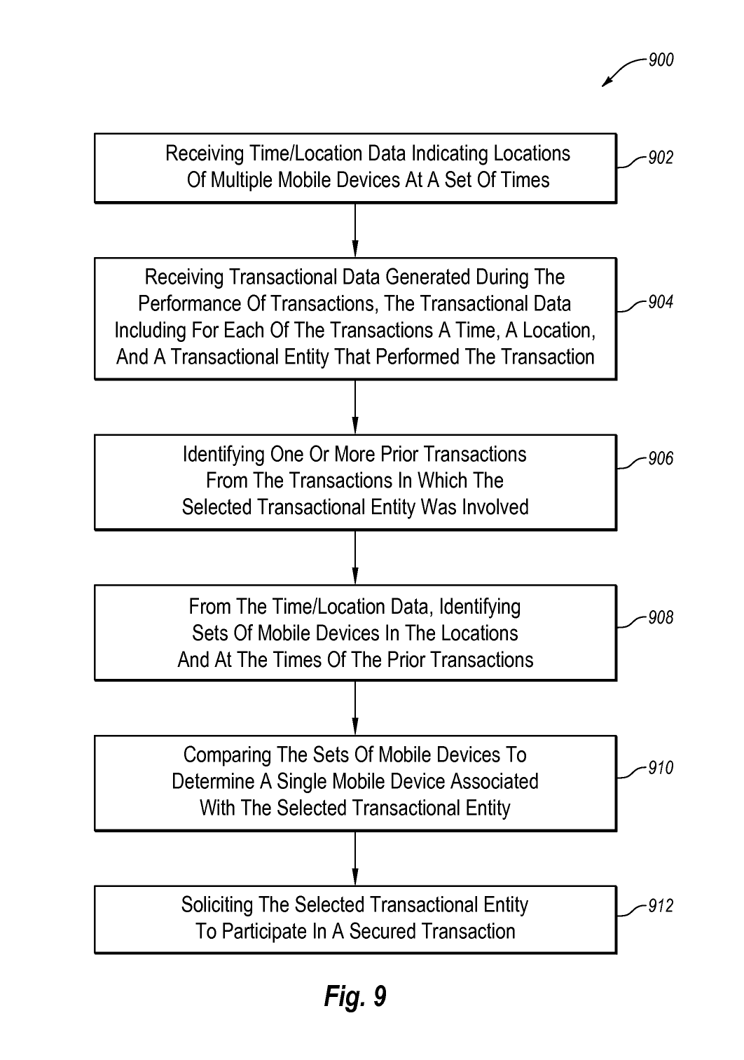

FIG. 9 is a flow diagram of an example method 900 of conducting a secured transaction with a selected transactional entity operating a mobile device. In some embodiments, the method 900 may be implemented by the identification system 100 of FIG. 1. Although illustrated as discrete blocks, various blocks may be divided into additional blocks, combined into fewer blocks, or eliminated, depending on the desired implementation.

The method 900 may begin at 902 by receiving time/location data indicating locations of a plurality of mobile devices at a set of times and at 904 by receiving transactional data generated during the performance of transactions. The transactional data may include for each of the transactions a time, a location, and a transactional entity that performed the transaction.

At 906, the method 900 may include identifying one or more prior transactions from the transactions in which the selected transactional entity was involved. At 908, from the time/location data, sets of mobile devices in the locations and at the times of the prior transactions are identified. At 910, the sets of mobile devices are compared to determine a single mobile device associated with the selected transactional entity. At 912, the method 900 may include soliciting the selected transactional entity to participate in a secured transaction.

In some embodiments, the method 900 may include validating that the single mobile device is associated with the selected transactional entity by communicating an identity verification to the single mobile device. Additionally or alternatively, the method 900 may include communicating a promotion to the selected transactional entity or correlating the locations and the times of one or more subsets of the prior transactions to determine other transactional entity information.

The embodiments described herein may include the use of a special purpose or general purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a “computer-readable medium.” Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the systems, methods, and other means for accomplishing the functions disclosed herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of associating mobile devices with transactional entities, the method comprising:
identifying a first transaction performed by a first transactional entity;
identifying a first set of mobile devices in a location of the first transaction at a time of the first transaction;
identifying a second transaction performed by the first transactional entity;
identifying a second set of mobile devices in a location of the second transaction at a time of the second transaction;
comparing the first set of mobile devices to the second set of mobile devices; and
when a single mobile device is common to the first set of mobile devices and the second set of mobile devices, associating the single mobile device with the first transactional entity.

2. The method of claim 1, wherein when multiple mobile devices are common to the first set of mobile devices and the second set of mobile devices, the method further comprises:
identifying a third transaction performed by the first transactional entity;
identifying a third set of mobile devices in a location of the third transaction at a time of the third transaction;
comparing the first set of mobile devices, the second set of mobile devices, and the third set of mobile devices; and
when a single mobile device is common to the first set of mobile devices, the second set of mobile devices, and the third set of mobile devices, associating the single mobile device with the first transactional entity.

3. The method of claim 1, wherein:
the first transaction and the second transaction performed by the first transactional entity are identified from transactional data; and
the first set of mobile devices and the second set of mobile devices are identified from time/location data obtained through pinging mobile devices by a network of cellular towers or by measuring an intensity of a wireless fidelity (Wi-Fi) signal between the mobile devices and one or more Wi-Fi access points.

4. The method of claim 3, further comprising analyzing the transactional data and the time/location data to determine other transactional information related to the first transactional entity.

5. The method of claim 4, wherein analyzing the transactional data includes correlating the location and the time of the first transaction with the time and the location of the second transaction to determine a transactional history of the first transactional entity, a pattern of typical transactions of the first transactional entity, or a present location of the first transactional entity.

6. The method of claim 1, further comprising verifying that the first transactional entity is associated with the single mobile device.

7. The method of claim 6, wherein verifying that the first transactional entity is associated with the single mobile device includes communicating an identity verification to the single mobile device.

8. The method of claim 7, further comprising:
receiving a response from the first transactional entity validating that the first transactional entity is associated with the single mobile device; and
soliciting the first transactional entity to participate in a secured transaction.

9. The method of claim 8, wherein the secured transaction includes searching a private document, accessing protected information, purchasing a product, or transferring funds between accounts held by the first transactional entity.

10. A non-transitory computer-readable storage medium having stored thereon instructions that, when executed by a machine, cause a system to perform the method of claim 1.

11. A method of identifying a mobile device associated with a selected transactional entity, the method comprising:
receiving time/location data indicating locations of a plurality of mobile devices at a set of times;
receiving transactional data generated during the performance of a plurality of transactions, the transactional data including for each of the plurality of transactions a time, a location, and a transactional entity that performed the transaction;
organizing the transactional data to enable identification of a first time and a first location for a first transaction performed by the selected transactional entity;
from the time/location data, determining a list of mobile devices in the first location at the first time of the performance of the first transaction; and
when the list of mobile devices includes a single mobile device, associating the single mobile device with the selected transactional entity.

12. The method of claim 11, wherein when the list of mobile devices includes multiple mobile devices, the method further comprises:
organizing the transactional data to enable identification of times and locations for each of the plurality of transactions performed by the selected transactional entity;
from the time/location data, determining a set of mobile devices in each of the locations at each of the times of the performance of each of the plurality of transactions performed by the selected transactional entity; and
comparing the sets of mobile devices to generate a list of possible mobile devices associated with the selected transactional entity.

13. The method of claim 12, further comprising:
communicating an identity verification to each of the mobile devices included in the list of possible mobile devices; and
validating that one of the mobile devices included in the list of possible mobile devices is associated with the selected transactional entity through reception of a response to the identity verification.

14. The method of claim 12, further comprising correlating the locations and the times of one or more subsets of the plurality of transactions performed by the selected transactional entity to determine a transactional history of the selected transactional entity, a pattern of typical transactions of the selected transactional entity, or a present location of the selected transactional entity.

15. The method of claim 12, further comprising outputting the list of possible mobile devices to an identifying entity.

16. The method of claim 15, wherein the identifying entity includes a bank.

17. A method of conducting a secured transaction with a selected transactional entity operating a mobile device, the method comprising:
receiving time/location data indicating locations of a plurality of mobile devices at a set of times;
receiving transactional data generated during the performance of a plurality of transactions, the transactional data including for each of the plurality of transactions a time, a location, and a transactional entity that performed a transaction;
identifying one or more prior transactions from the plurality of transactions in which the selected transactional entity was involved;
from the time/location data, identifying sets of mobile devices in the locations and at the times of the prior transactions;
comparing the sets of mobile devices to determine a single mobile device associated with the selected transactional entity; and
soliciting the selected transactional entity to participate in a secured transaction.

18. The method of claim 17, further comprising validating the single mobile device is associated with the selected transactional entity by communicating an identity verification to the single mobile device.

19. The method of claim 17, further comprising communicating a promotion to the selected transactional entity.

20. The method of claim 17, further comprising correlating the locations and the times of one or more subsets of the prior transactions to determine other transactional entity information.
